(19) United States
(12) Patent Application Publication
(10) Pub. No.: US 2007/0115920 A1
(43) Pub. Date: May 24, 2007

(54) Dialog authoring and execution framework

(75) Inventor: Anand Ramakrishna, Redmond, WA (US)

Correspondence Address: WESTMAN CHAMPLIN (MICROSOFT CORPORATION), SUITE 1400, 900 SECOND AVENUE SOUTH, MINNEAPOLIS, MN, 55402-3319, US

(73) Assignee: Microsoft Corporation, Redmond, WA (US)

(21) Appl. No.: 11/253,047

(22) Filed: Oct. 18, 2005

(51) Int. Cl. H04L 12/66

(52) U.S. Cl. 370/352

(57) ABSTRACT

A framework to author and execute dialog applications is utilized in a communication architecture. The applications can be used with a plurality of different modes of communication. A message processed by the dialog application is used to determine a dialog state and provide an associated response.

### BACKGROUND

The discussion below is merely provided for general background information and is not intended to be used as an aid in determining the scope of the claimed subject matter.

Remote applications from a broad variety of industries can be utilized across a computer network. For example, the applications include contact center self-service applications such as call routing and customer account/personal information access. Other contact center applications are possible including travel reservations, financial and stock applications and customer relationship management. Additionally, information technology groups can benefit from applications in the areas of sales and field-service automation, E-commerce, auto-attendants, help desk password reset applications and speech-enabled network management, for example.

Traditional customer care has typically been handled through call centers manned by several human agents who answer telephones and respond to customer inquiries. Currently, many of these call centers are automated through telephony based Interactive Voice Response (IVR) systems employing a combination of Dual Tone Multi Frequency (DTMF) and Automatic Speech Recognition (ASR) technologies. Furthermore, customer care has been extended past telephony based systems into Instant Messaging (IM) and Email based systems. These different channels provide additional choices to the end customer, thereby increasing overall customer satisfaction. Automation of customer care across these various channels has currently been difficult as different tools are used for each channel.

### SUMMARY

This Summary is provided to introduce some concepts in a simplified form that are further described below in the Detailed Description. This Summary is not intended to identify key features or essential features of the claimed subject matter, nor is it intended to be used as an aid in determining the scope of the claimed subject matter.

A framework to author and execute dialog applications is utilized in a communication architecture. The applications can be used with a plurality of different modes of communication. A message processed by the dialog application is used to determine a dialog state and provide an associated response.

### BRIEF DESCRIPTION OF THE DRAWINGS

FIG. 1 is a front view of an exemplary mobile device.

FIG. 2 is a block diagram of functional components for the mobile device of FIG. 1.

FIG. 3 is a front view of an exemplary phone.

FIG. 4 is a block diagram of a general computing environment.

FIG. 5 is a block diagram of a communication architecture for handling communication messages.

FIG. 6 is a diagram of a plurality of dialog states.

FIG. 7 is a block diagram of components in a user interface.

FIG. 8 is a flow diagram of a method for handling communication messages.

### DETAILED DESCRIPTION

Before describing an agent for handling communication messages and methods for implementing the same, it may be useful to describe generally computing devices that can function in a communication architecture. These devices can be used in various computing settings to utilize the agent across a computer network. For example, the devices can interact with the agent using natural language input of different modalities including text and speech. The devices discussed below are exemplary only and are not intended to limit the subject matter described herein.

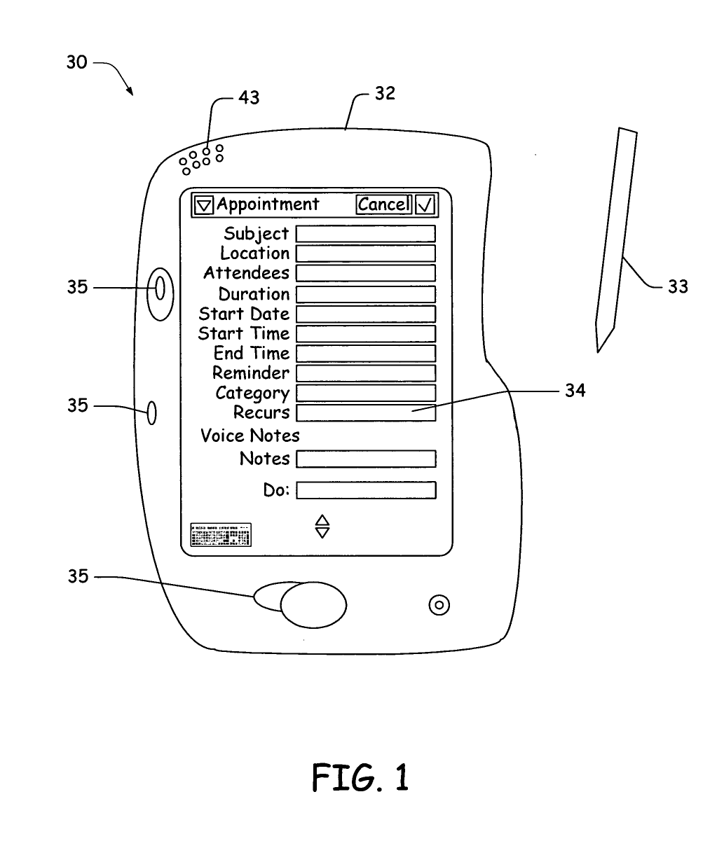

An exemplary form of a data management mobile device 30 is illustrated in FIG. 1. The mobile device 30 includes a housing 32 and has a user interface including a display 34, which uses a contact sensitive display screen in conjunction with a stylus 33. The stylus 33 is used to press or contact the display 34 at designated coordinates to select a field, to selectively move a starting position of a cursor, or to otherwise provide command information such as through gestures or handwriting. Alternatively, or in addition, one or more buttons 35 can be included on the device 30 for navigation. In addition, other input mechanisms such as rotatable wheels, rollers or the like can also be provided. Another form of input can include a visual input such as through computer vision.

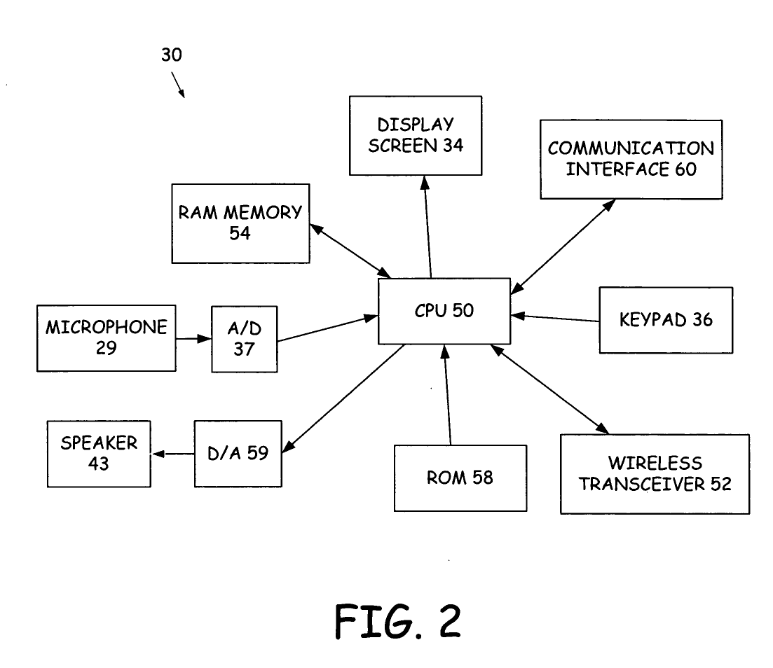

Referring now to FIG. 2, a block diagram illustrates the functional components comprising the mobile device 30. A central processing unit (CPU) 50 implements the software control functions. CPU 50 is coupled to display 34 so that text and graphic icons generated in accordance with the controlling software appear on the display 34. A speaker 43 can be coupled to CPU 50 typically with a digital-to-analog converter 59 to provide an audible output.

Data that is downloaded or entered by the user into the mobile device 30 is stored in a non-volatile read/write random access memory store 54 bi-directionally coupled to the CPU 50. Random access memory (RAM) 54 provides volatile storage for instructions that are executed by CPU 50, and storage for temporary data, such as register values. Default values for configuration options and other variables are stored in a read only memory (ROM) 58. ROM 58 can also be used to store the operating system software for the device that controls the basic functionality of the mobile device 30 and other operating system kernel functions (e.g., the loading of software components into RAM 54).

RAM 54 also serves as storage for the code in the manner analogous to the function of a hard drive on a PC that is used to store application programs. It should be noted that although non-volatile memory is used for storing the code, it alternatively can be stored in volatile memory that is not used for execution of the code.

Wireless signals can be transmitted/received by the mobile device through a wireless transceiver 52, which is coupled to CPU 50. An optional communication interface 60 can also be provided for downloading data directly from a computer (e.g., desktop computer), or from a wired network, if desired. Accordingly, interface 60 can comprise various forms of communication devices, for example, an infrared link, modem, a network card, or the like.

Mobile device 30 includes a microphone 29, an analog-to-digital (A/D) converter 37, and an optional recognition program (speech, DTMF, handwriting, gesture or computer vision) stored in store 54. By way of example, in response to audible information, instructions or commands from a user of device 30, microphone 29 provides speech signals, which are digitized by A/D converter 37. The speech recognition program can perform normalization and/or feature extraction functions on the digitized speech signals to obtain intermediate speech recognition results.

Using wireless transceiver 52 or communication interface 60, speech and other data can be transmitted remotely, for example to an agent. When transmitting speech data, a remote speech server can be utilized. Recognition results can be returned to mobile device 30 for rendering (e.g. visual and/or audible) thereon, and eventual transmission to the agent, wherein the agent and mobile device 30 interact based on communication messages.

Similar processing can be used for other forms of input. For example, handwriting input can be digitized with or without pre-processing on device 30. Like the speech data, this form of input can be transmitted to a server for recognition wherein the recognition results are returned to at least one of the device 30 and/or a remote agent. Likewise, DTMF data, gesture data and visual data can be processed similarly. Depending on the form of input, device 30 (and the other forms of clients discussed below) would include necessary hardware such as a camera for visual input.

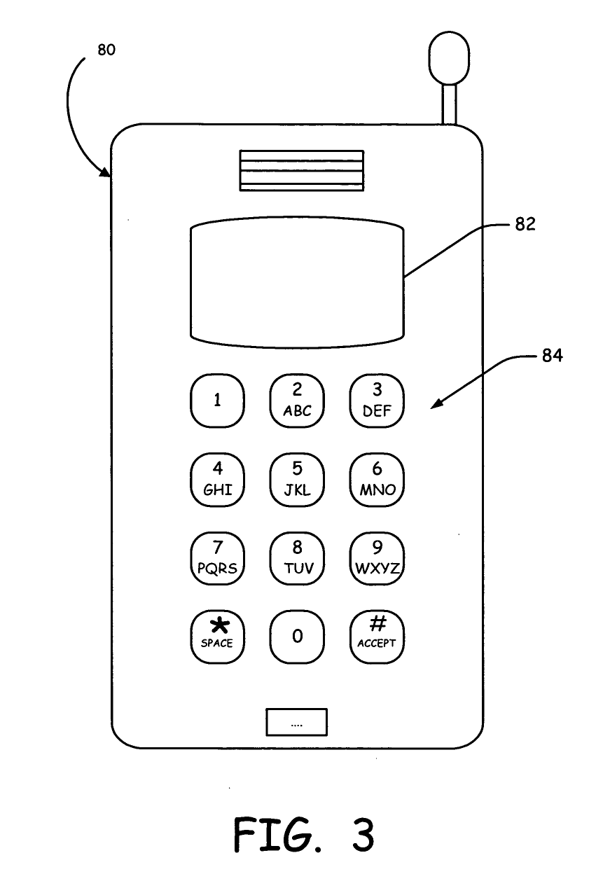

FIG. 3 is a plan view of an exemplary embodiment of a portable phone 80. The phone 80 includes a display 82 and a keypad 84. Generally, the block diagram of FIG. 2 applies to the phone of FIG. 3, although additional circuitry necessary to perform other functions may be required. For instance, a transceiver necessary to operate as a phone will be required for the embodiment of FIG. 2; however, such circuitry is not pertinent to the present invention.

The agent is also operational with numerous other general purpose or special purpose computing systems, environments or configurations. Examples of well known computing systems, environments, and/or configurations that may be suitable for use with the invention include, but are not limited to, regular telephones (without any screen), personal computers, server computers, hand-held or laptop devices, multiprocessor systems, microprocessor-based systems, set top boxes, programmable consumer electronics, radio frequency identification (RFID) devices, network PCs, minicomputers, mainframe computers, distributed computing environments that include any of the above systems or devices, and the like.

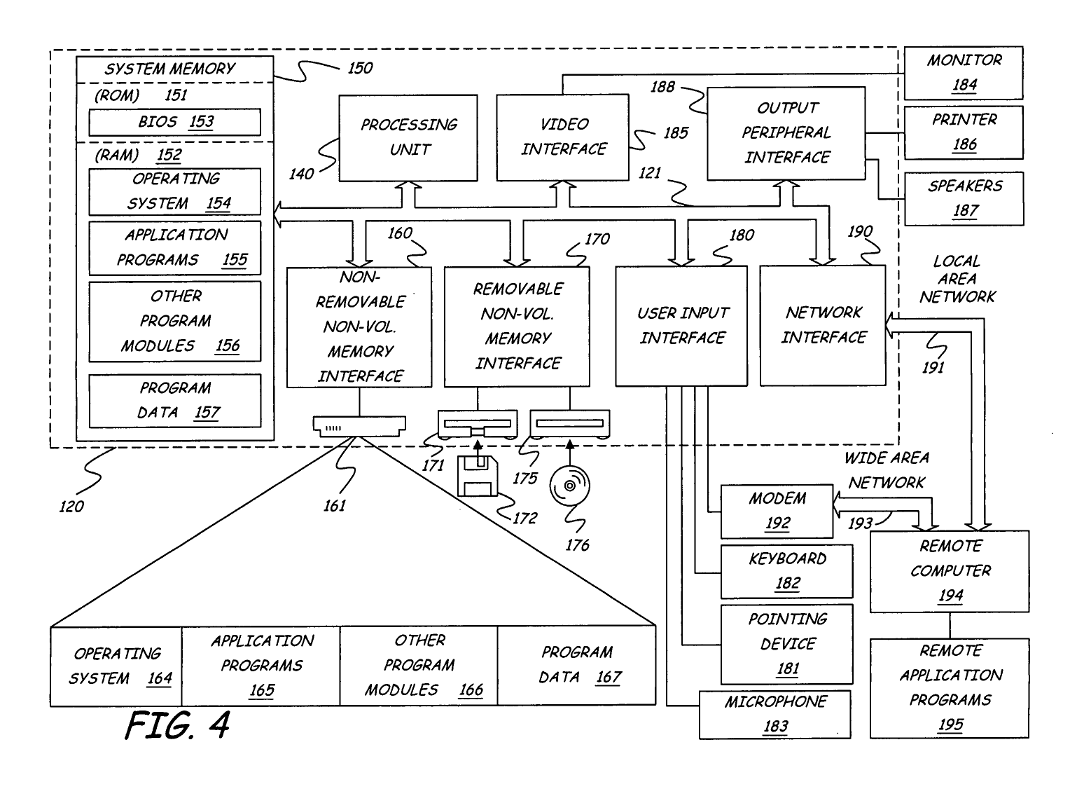

The following is a brief description of a general purpose computer 120 illustrated in FIG. 4. However, the computer 120 is again only one example of a suitable computing environment and is not intended to suggest any limitation as to the scope of use or functionality of the invention. Neither should the computer 120 be interpreted as having any dependency or requirement relating to any one or combination of components illustrated therein.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices. Tasks performed by the programs and modules are described below and with the aid of figures. Those skilled in the art can implement the description and figures as processor executable instructions, which can be written on any form of a computer readable medium.

With reference to FIG. 4, components of computer 120 may include, but are not limited to, a processing unit 140, a system memory 150, and a system bus 141 that couples various system components including the system memory to the processing unit 140. The system bus 141 may be any of several types of bus structures including a memory bus or memory controller, a peripheral bus, and a local bus using any of a variety of bus architectures. By way of example, and not limitation, such architectures include Industry Standard Architecture (ISA) bus, Universal Serial Bus (USB), Micro Channel Architecture (MCA) bus, Enhanced ISA (EISA) bus, Video Electronics Standards Association (VESA) local bus, and Peripheral Component Interconnect (PCI) bus also known as Mezzanine bus. Computer 120 typically includes a variety of computer readable mediums. Computer readable mediums can be any available media that can be accessed by computer 120 and includes both volatile and nonvolatile media, removable and non-removable media. By way of example, and not limitation, computer readable mediums may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 120.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, FR, infrared and other wireless media. Combinations of any of the above should also be included within the scope of computer readable media.

The system memory 150 includes computer storage media in the form of volatile and/or nonvolatile memory such as read only memory (ROM) 151 and random access memory (RAM) 152. A basic input/output system 153 (BIOS), containing the basic routines that help to transfer information between elements within computer 120, such as during start-up, is typically stored in ROM 151. RAM 152 typically contains data and/or program modules that are immediately accessible to and/or presently being operated on by processing unit 140. By way of example, and not limitation, FIG. 4 illustrates operating system 54, application programs 155, other program modules 156, and program data 157.

The computer 120 may also include other removable/non-removable volatile/nonvolatile computer storage media. By way of example only, FIG. 4 illustrates a hard disk drive 161 that reads from or writes to non-removable, nonvolatile magnetic media, a magnetic disk drive 171 that reads from or writes to a removable, nonvolatile magnetic disk 172, and an optical disk drive 175 that reads from or writes to a removable, nonvolatile optical disk 176 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 161 is typically connected to the system bus 141 through a non-removable memory interface such as interface 160, and magnetic disk drive 171 and optical disk drive 175 are typically connected to the system bus 141 by a removable memory interface, such as interface 170.

The drives and their associated computer storage media discussed above and illustrated in FIG. 4, provide storage of computer readable instructions, data structures, program modules and other data for the computer 120. In FIG. 4, for example, hard disk drive 161 is illustrated as storing operating system 164, application programs 165, other program modules 166, and program data 167. Note that these components can either be the same as or different from operating system 154, application programs 155, other program modules 156, and program data 157. Operating system 164, application programs 165, other program modules 166, and program data 167 are given different numbers here to illustrate that, at a minimum, they are different copies.

A user may enter commands and information into the computer 120 through input devices such as a keyboard 182, a microphone 183, and a pointing device 181, such as a mouse, trackball or touch pad. Other input devices (not shown) may include a joystick, game pad, satellite dish, scanner, or the like. These and other input devices are often connected to the processing unit 140 through a user input interface 180 that is coupled to the system bus, but may be connected by other interface and bus structures, such as a parallel port, game port or a universal serial bus (USB). A monitor 184 or other type of display device is also connected to the system bus 141 via an interface, such as a video interface 185. In addition to the monitor, computers may also include other peripheral output devices such as speakers 187 and printer 186, which may be connected through an output peripheral interface 188.

The computer 120 may operate in a networked environment using logical connections to one or more remote computers, such as a remote computer 194. The remote computer 194 may be a personal computer, a hand-held device, a server, a router, a network PC, a peer device or other common network node, and typically includes many or all of the elements described above relative to the computer 120. The logical connections depicted in FIG. 4 include a local area network (LAN) 191 and a wide area network (WAN) 193, but may also include other networks. Such networking environments are commonplace in offices, enterprise-wide computer networks, intranets and the Internet.

When used in a LAN networking environment, the computer 120 is connected to the LAN 191 through a network interface or adapter 190. When used in a WAN networking environment, the computer 120 typically includes a modem 192 or other means for establishing communications over the WAN 193, such as the Internet. The modem 192, which may be internal or external, may be connected to the system bus 141 via the user input interface 180, or other appropriate mechanism. In a networked environment, program modules depicted relative to the computer 120, or portions thereof, may be stored in the remote memory storage device. By way of example, and not limitation, FIG. 4 illustrates remote application programs 195 as residing on remote computer 194. It will be appreciated that the network connections shown are exemplary and other means of establishing a communications link between the computers may be used.

Typically, application programs 155 have interacted with a user through a command line or a Graphical User Interface (GUI) through user input interface 180. However, in an effort to simplify and expand the use of computer systems, inputs have been developed which are capable of receiving natural language input from the user. In contrast to natural language or speech, a graphical user interface is precise. A well designed graphical user interface usually does not produce ambiguous references or require the underlying application to confirm a particular interpretation of the input received through the interface 180. For example, because the interface is precise, there is typically no requirement that the user be queried further regarding the input, e.g., “Did you click on the ‘ok’ button?” Typically, an object model designed for a graphical user interface is very mechanical and rigid in its implementation.

In contrast to an input from a graphical user interface, a natural language query or command will frequently translate into not just one, but a series of function calls to the input object model. In contrast to the rigid, mechanical limitations of a traditional line input or graphical user interface, natural language is a communication means in which human interlocutors rely on each other's intelligence, often unconsciously, to resolve ambiguities. In fact, natural language is regarded as “natural” exactly because it is not mechanical. Human interlocutors can resolve ambiguities based upon contextual information and cues regarding any number of domains surrounding the utterance. With human interlocutors, the sentence, “Forward the minutes to those in the review meeting on Friday” is a perfectly understandable sentence without any further explanations. However, from the mechanical point of view of a machine, specific details must be specified such as exactly what document and which meeting are being referred to, and exactly to whom the document should be sent.

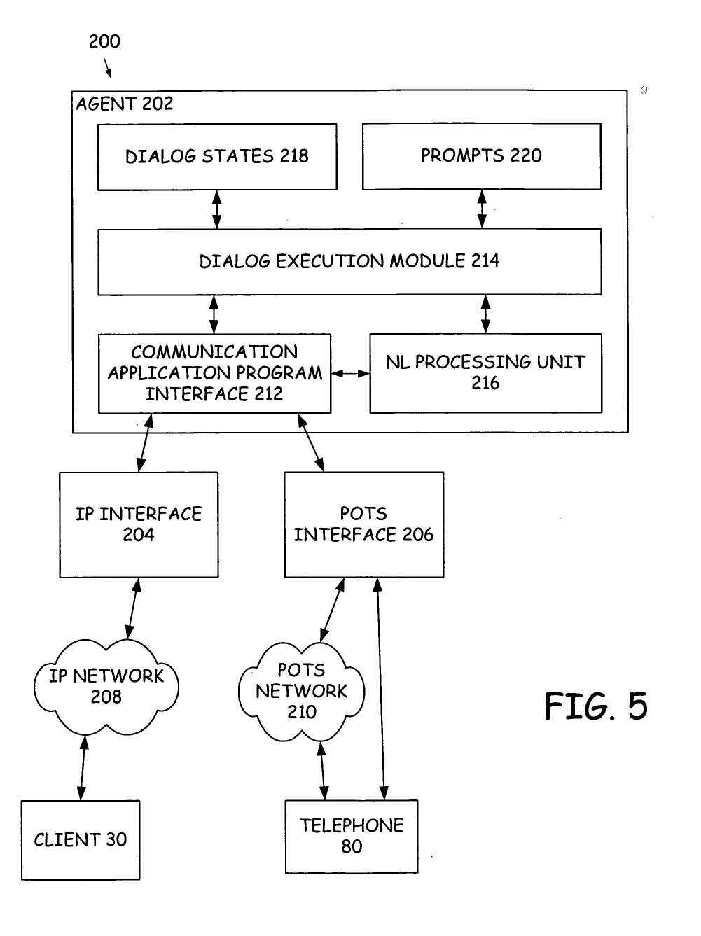

FIG. 5 illustrates an exemplary communication architecture 200 with an agent 202. Agent 202 receives communication requests and/or messages from an initiator and performs tasks based on the requests and/or messages. The messages can be routed to a destination. An initiator can include a person, a device, a telephone, a remote personal information manager, etc. that connects to agent 202. The messages from the initiator can take many forms including real time voice (for example from a simple telephone or through a voice over Internet protocol source), real time text (such as instant messaging), non-real time voice (for example a voicemail message) and non-real time text (for example through short message service (SMS) or email). Tasks are automatically performed by agent 202, for example responding to a customer care inquiry sent by an initiator.

In one embodiment, agent 202 can be implemented on a general purpose computer such as computer 120 discussed above. Agent 202 represents a single point of contact for a user dialog application. Thus, if a person wishes to interact with the dialog application, communication requests and messages are handled through agent 202. In this manner, the person need not contact agent 202 using a particular device. The person only needs to contact agent 202 through any desired device, which handles and routes incoming communication requests and messages.

An initiator of a communication request or message can contact agent 202 through a number of different modes of communication. Generally, agent 202 can be accessed through a client such as a mobile device 30 (which herein also represents other forms of computing devices having a display screen, a microphone, a camera, a touch sensitive panel, etc., as required based on the form of input), or through phone 80 wherein communication is made audibly or through tones generated by phone 80 in response to keys depressed and wherein information from agent 202 can be provided audibly back to the user.

More importantly though, agent 202 is unified in that whether information is obtained through device 30 or phone 80, agent 202 can support either mode of operation. Agent 202 is operably coupled to multiple interfaces to receive communication messages. Thus, agent 202 can provide a response to different types of devices based on a mode of communication for the device.

IP interface 204 receives and transmits information using packet switching technologies, for example using TCP/IP (Transmission Control Protocol/Internet Protocol). A computing device communicating using an internet protocol can thus interface with IP interface 204.

POTS (Plain Old Telephone System, also referred to as Plain Old Telephone Service) interface 206 can interface with any type of circuit switching system including a Public Switch Telephone Network (PSTN), a private network (for example a corporate Private Branch Exchange (PBX)) and/or combinations thereof. Thus, POTS interface 206 can include an FXO (Foreign Exchange Office) interface and an FXS (Foreign Exchange Station) interface for receiving information using circuit switching technologies.

IP interface 204 and POTS interface 206 can be embodied in a single device such as an analog telephony adapter (ATA). Other devices that can interface and transport audio data between a computer and a POTS can be used, such as “voice modems” that connect a POTS to a computer using a telephone application program interface (TAPI).

As illustrated in FIG. 5, device 30 and agent 202 are commonly connected, and separately addressable, through a network 208, herein a wide area network such as the Internet. It therefore is not necessary that client 30 and agent 202 be physically located adjacent each other. Client 30 can transmit data, for example speech, text and video data, using a specified protocol to IP interface 204. In one embodiment, communication between client 30 and IP interface 204 uses standardized protocols, for example SIP with RTP (Session Initiator Protocol with Realtime Transport Protocol), both Internet Engineering Task Force (IETF) standards.

Access to agent 202 through phone 80 includes connection of phone 80 to a wired or wireless telephone network 210 that, in turn, connects phone 80 to agent 202 through a FXO interface. Alternatively, phone 80 can directly connect to agent 202 through a FXS interface, which is a part of POTS interface 206.

Both IP interface 204 and POTS interface 206 connect to agent 202 through a communication application programming interface (API) 212. One implementation of communication API 212 is Microsoft Real-Time Communication (RTC) Client API, developed by Microsoft Corporation of Redmond, Wash. Another implementation of communication API 212 is the Computer Supported Telecommunication Architecture (ECMA-269/ISO 18051), or CSTA, an ISO/ECMA standard. Communication API 212 can facilitate multimodal communication applications, including applications for communication between two computers, between two phones and between a phone and a computer. Communication API 212 can also support audio and video calls, text-based messaging and application sharing. Thus, agent 202 is able to initiate communication to client 30 and/or phone 80.

Agent 202 also includes a dialog execution module 214, a natural language processing unit 216, dialog states 218 and prompts 220. Dialog execution module 214 includes logic to handle communication requests and messages from communication API 212 as well as performs tasks based on dialog states 218. These tasks can include transmitting a prompt from prompts 220.

Dialog execution module 214 utilizes natural language processing unit 216 to perform various natural language processing tasks. Natural language processing unit 216 includes a recognition engine that is used to identify features in the user input. Recognition features for speech are usually words in the spoken language while recognition features for handwriting usually correspond to strokes in the user's handwriting. In one particular example, a language model such as a grammar can be used to recognize text within a speech utterance. As is known, recognition can also be provided for visual inputs.

Dialog execution module 214 can use objects recognized by natural language processing unit 216 to determine a desired dialog state from dialog states 218. Dialog execution module 214 also accesses prompts 220 to provide an output to a person based on user input. Dialog states 218 can be stored as one or more files to be accessed by dialog execution module 214. Prompts 220 can be integrated into dialog states 218 or stored and accessed separately from dialog states 218. Prompts can be stored as text, audio and/or video data that is transmitted via communication API 212 to a user based on a request from the user, for example, an initial prompt may include, “Welcome to Acme Company Help Center, how can I help you?” The prompt is transmitted based on a mode of communication for the user. If the user connects to agent 202 using a phone, the prompt can be played audibly through the phone. If the user sends an email message, the agent 202 can respond with an email message.

In operation, dialog execution module 214 interprets communication messages received from a user in order to traverse through a dialog that includes a plurality of dialog states, for example dialog states 218. In one embodiment, the dialog can be configured as a help center with prompts for use in answering questions from a user. The dialog states 218 can be stored as a file to be accessed by dialog execution module 214. The file can be authored independent of a particular communication mode that is used by a user to access agent 202. Thus, dialog execution module 214 can include an application programming interface (API) to access dialog states 218.

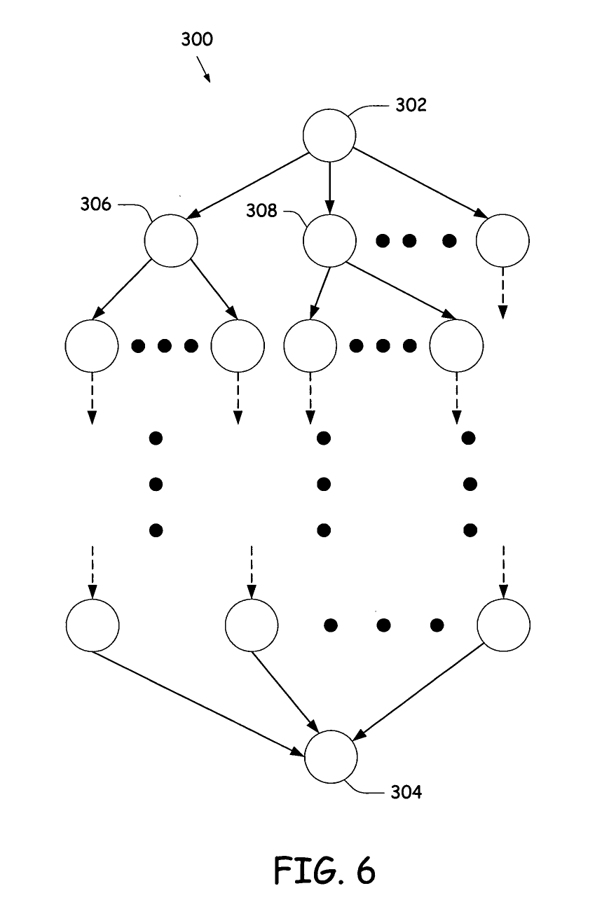

FIG. 6 is a diagram of an exemplary dialog 300 including a plurality of dialog states. Each state is represented by a circle and arrows represent transitions between two states. Dialog 300 includes an initial state 302 and an end state 304. After a communication message is received by agent 202, dialog 300 is initiated and begins with state 302. State 302 can include one or more processes or tasks to be performed. For example, dialog state 302 can include a welcome prompt to be played and/or transmitted to user. After the initial state 302, a further communication message can be received. Based on the communication message received, dialog 300 moves to a next state. For example, dialog 300 can transition to state 306, state 308, etc. Each of these states can include further associated tasks and prompts to conduct a dialog with a user. These states also include transitions to other states in dialog 300. Ultimately, dialog 300 is traversed until end state 304 is reached.

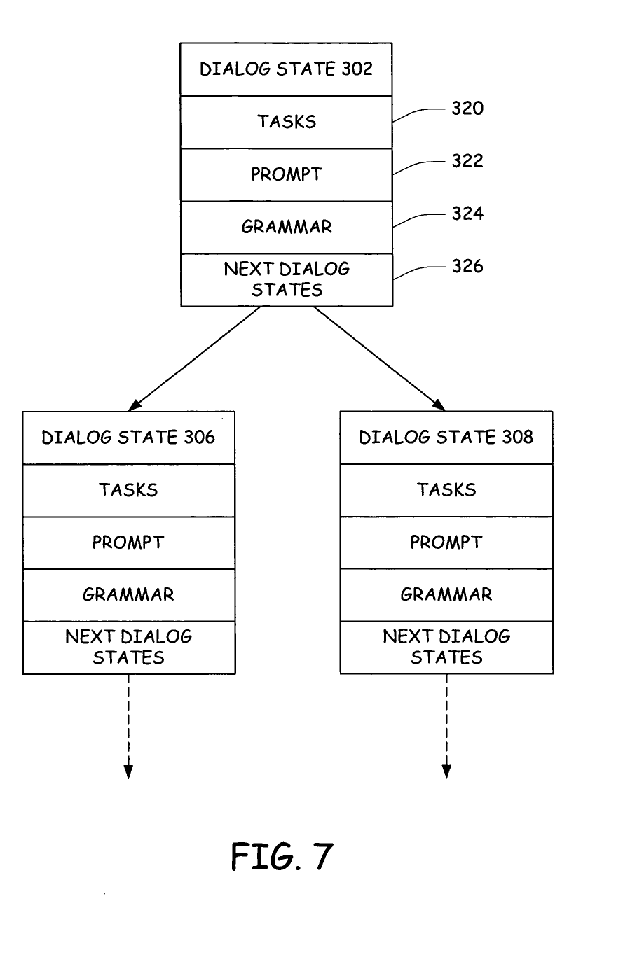

FIG. 7 is a block diagram of components in a user interface that allows a person to author a dialog, for example dialog 300. The interface allows the person to create a state-based dialog. In one embodiment, the interface enables creation of a dialog using a flowcharting tool. The tool allows the person to create dialog states as well as various properties associated with the dialog states. For example, the person can specify tasks 320, a prompt 322, a grammar 324 and next dialog states 326 for dialog state 302.

Tasks 320 include one or more processes that are run for dialog state 302. Prompt 322 includes text, audio and/or video data that can be transmitted via communication API 212. Grammar 324 allows an author to express natural language input that will drive state changes from dialog state 302. For example, grammar 324 can be a context-free grammar, n-gram, hybrid or other. Next dialog states 326 that can follow dialog state 302, in this case dialog states 306 and 308, can also be specified. Dialog states 306 and 308 can include their own specified tasks, prompts, grammars and next dialog states.

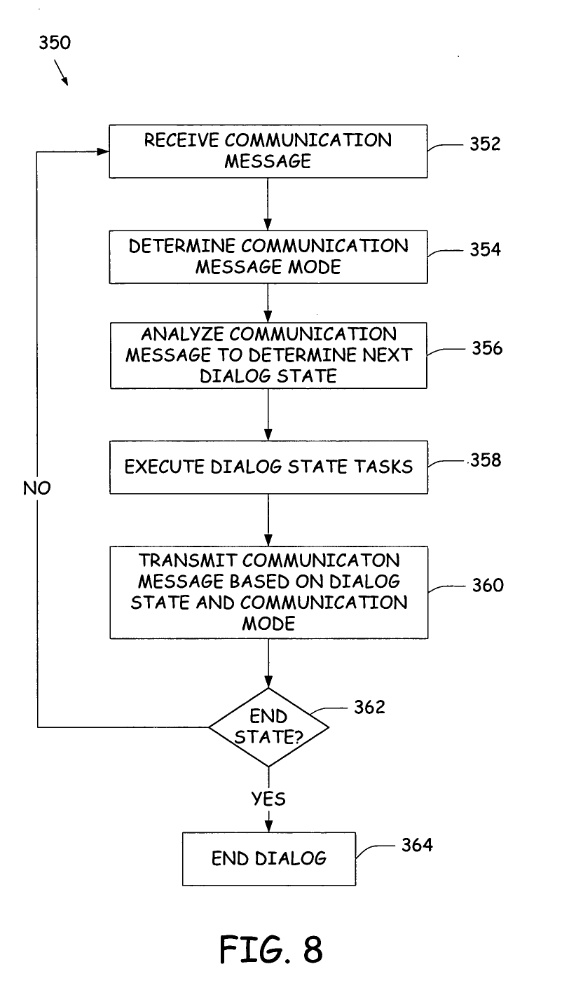

FIG. 8 is a flow diagram of a method 350 performed by dialog execution module 214. At step 352, a communication message is received. Next, at step 354, a communication mode is determined based on the message received. For example, the mode can be an email message, an instant message or a connection via a telephone system. At step 356, the communication message is analyzed to determine a next dialog state for the dialog. This step can include dialog execution module 214 accessing natural language processing unit 216 to identify semantic information within the message. The semantic information can be used with a grammar to determine a next dialog state. At step 358, tasks associated with the dialog state are executed. A communication message is then transmitted based on the dialog state and the communication mode at step 360. For example, the message can include one or more prompts associated with the dialog state. At step 362, it is determined whether or not the dialog is at an end state. If the dialog is not at an end state, the method 350 will proceed to step 352 to wait for a further communication message. If the end state has been reached, method 350 ends at step 364.

A framework for authoring a dialog independent of a communication mode across a channel can thus be realized. A dialog execution module can communicate through various communication channels to communicate with a user. The dialog is accessed by the dialog execution module such that the dialog execution module can initiate and conduct a dialog regardless of a mode of communication that the user desires.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method of handling communication messages in a communication architecture, comprising:
receiving a first communication message from a source;
identifying a mode of communication associated with the first communication message;
determining a dialog state based on the first communication message;
transmitting a second communication message based on the dialog state to the source using the mode of communication.

2. The method of claim 1 and further comprising accessing a dialog file containing a plurality of specified dialog states.

3. The method of claim 2 wherein each of the dialog states includes associated properties including at least one of a task, a prompt and a related dialog state.

4. The method of claim 1 and further comprising performing a task based on the dialog state.

5. The method of claim 1 and further comprising analyzing the first communication message to determine semantic information contained therein and wherein the dialog state is determined based on the semantic information.

6. The method of claim 1 wherein the mode of communication is one of email, instant messaging and telephony.

7. The method of claim 1 wherein the first communication message includes one of speech data and text data.

8. A computer-readable medium adapted to process a communication message from a source having a mode of communication, comprising:
a dialog execution module adapted to access a plurality of dialog states to determine a dialog state based on the communication message; and
a communication interface coupled to the dialog execution module and adapted to transmit a response to the source based on the dialog state and the mode of communication.

9. The computer-readable medium of claim 8 wherein the dialog execution module is further adapted to analyze the communication message to determine semantic information contained therein.

10. The computer-readable medium of claim 9 wherein the next dialog state is determined based on the semantic information.

11. The computer-readable medium of claim 10 wherein the dialog execution module is adapted to access a language model to determine the dialog state based on the semantic information.

12. The computer-readable medium of claim 8 wherein the communication interface is adapted to transmit the response to an internet protocol source and a POTS source.

13. The computer-readable medium of claim 8 wherein the dialog execution module is adapted to access a prompt to determine the response.

14. A system comprising:
a communication interface adapted to receive communication messages from a plurality of different modes of communication and transmit communication messages based on the plurality of different modes of communication;
a dialog file including a plurality of dialog states, each dialog state having associated properties; and
a dialog execution module coupled to the communication interface to receive communication messages therefrom, adapted to access the dialog file to determine a dialog state based on a particular communication message and provide a response associated with the dialog state to the communication interface.

15. The system of claim 14 wherein the associated properties include a prompt, a language model and a related dialog state.

16. The system of claim 14 and further comprising a natural language processing unit coupled to the dialog execution module to identify semantic information within the communication messages.

17. The system of claim 14 and further comprising an internet protocol interface and a POTS interface coupled to the communication interface.

18. The system of claim 14 wherein the dialog execution module includes an application programming interface to access the dialog file.

19. The system of claim 14 wherein the communication messages include at least one speech data and text data.

20. The system of claim 14 wherein the communication interface is adapted to transmit at least one of an email message and an audio message.
